(19) United States
(12) Patent Application Publication
(10) Pub. No.: US 2015/0322889 A1
(43) Pub. Date: Nov. 12, 2015

(54) Crankshaft For Engine And Engine Assembly Employing The Same

(71) Applicant: Ford Global Technologies, LLC, Dearborn, MI (US)

(72) Inventors: Ben Xuehai Ni, Canton, MI (US); Nathaniel David Hansen, Canton, MI (US); Shaji Mathews, Ypsilanti, MI (US)

(73) Assignee: Ford Global Technologies, LLC, Dearborn, MI (US)

(21) Appl. No.: 14/273,616

(22) Filed: May 9, 2014

(51) Int. Cl. F02F 7/00

(52) U.S. Cl. CPC F02F 7/0043

(57) ABSTRACT

A crankshaft for an engine, includes: a first number of main journals including a head main journal positioned between one or more first-side main journals and one or more second-side main journals, the head main journal supporting a grooved shell with one or more oil grooves, a second number of pin journals including one or more first-side pin journals and one or more second-side pin journals, the head main journal connected to and being positioned between the first-side and second-side pin journals, a first extended passageway defined by and in communication with the head main journal, the one or more first-side main journals and the one or more first-side pin journals, and a second extended passageway defined by and in communication with the head main journal, the one or more second-side main journals and the one or more second-side pin journals.

### TECHNICAL FIELD

The disclosed inventive concept relates generally to a crankshaft for engine and an engine assembly employing the same.

### BACKGROUND

In internal combustion engine, crankshafts are typically lubricated and cooled by oil supplied to main journals. Lubrication is then further provided to pin journals via oil passages formed with the crankshafts. In many existing technologies, each of the main journals is supplied with an independent source of oil supply such that the oil is then transported to the nearest pin journals for lubrication.

For instance, US 2004/0103872 A1 illustrates lubricating oil supply system, which is provided for the connecting rod bearings of a crankshaft of a multi-cylinder internal combustion engine.

In another example, U.S. Pat. No. 5,138,991 discloses a crankshaft for an internal combustion engine wherein each main bearing journal has an oil supply groove for supplying oil to adjacent oil reservoirs though oil passages.

### SUMMARY

In one or more embodiments, the present invention provides a crankshaft for an engine which includes a first number of main journals including a head main journal positioned between one or more first-side main journals and one or more second-side main journals, the head main journal supporting a grooved shell with one or more oil grooves, a second number of pin journals including one or more first-side pin journals and one or more second-side pin journals, the head main journal connected to and being positioned between the first-side and second-side pin journals, a first extended passageway defined by and in communication with the head main journal, the one or more first-side main journals and the one or more first-side pin journals, and a second extended passageway defined by and in communication with the head main journal, the one or more second-side main journals and the one or more second-side pin journals.

In another or more embodiments, the present invention provides engine assembly including journals consecutively arranged as first main, first pin, second main, second pin, third main, third pin, fourth main, fourth pin, and fifth main, wherein a first passageway is defined by and connects the second main journal and first and second pin journals.

In yet another or more embodiments, the present invention further provides an engine assembly including journals consecutively arranged as first main, first pin, second main, second pin, third main, third pin, fourth main, fourth pin, and fifth main, wherein a first passageway is defined by and connects the second main journal and first and second pin journals, a second passageway is defined by and connects the third main and the second pin journals, a third passageway is defined by and connects the third main and the third pin journals, a fourth passageway is defined by and connects the fourth main journal and the third and fourth pin journals, a fifth passageway is defined by and connects the fifth main and the fourth pin journals, and a sixth passageway is defined by and connects the first main and the first pin journals.

One or more advantageous features as described herein will be readily apparent from the following detailed description of one or more embodiments when taken in connection with the accompanying drawings.

### BRIEF DESCRIPTION OF THE DRAWINGS

For a more complete understanding of one or more embodiments of the present invention, reference is now made to the one or more embodiments illustrated in greater detail in the accompanying drawings and described below wherein:

FIG. 1 illustratively depicts an engine assembly in one or more embodiments;

FIG. 2A illustratively depicts a perspective view of a crankshaft of the engine assembly referenced in FIG. 1;

FIG. 2B illustratively depicts a cross-sectional view of the crankshaft referenced in FIG. 2A;

FIG. 3A illustratively depicts an alternative view of a head main journal referenced in FIG. 2A;

FIG. 3B illustratively depicts another alternative view of a head main journal referenced in FIG. 2A;

FIG. 4A illustratively depicts an alternative view of a pin journal referenced in FIG. 2A;

FIG. 4B illustratively depicts another alternative view of a pin journal referenced in FIG. 2A; and

FIG. 5 illustratively depicts a cross-sectional, alternative view of the crankshaft referenced in FIG. 2A.

### DETAILED DESCRIPTION OF ONE OR MORE EMBODIMENTS

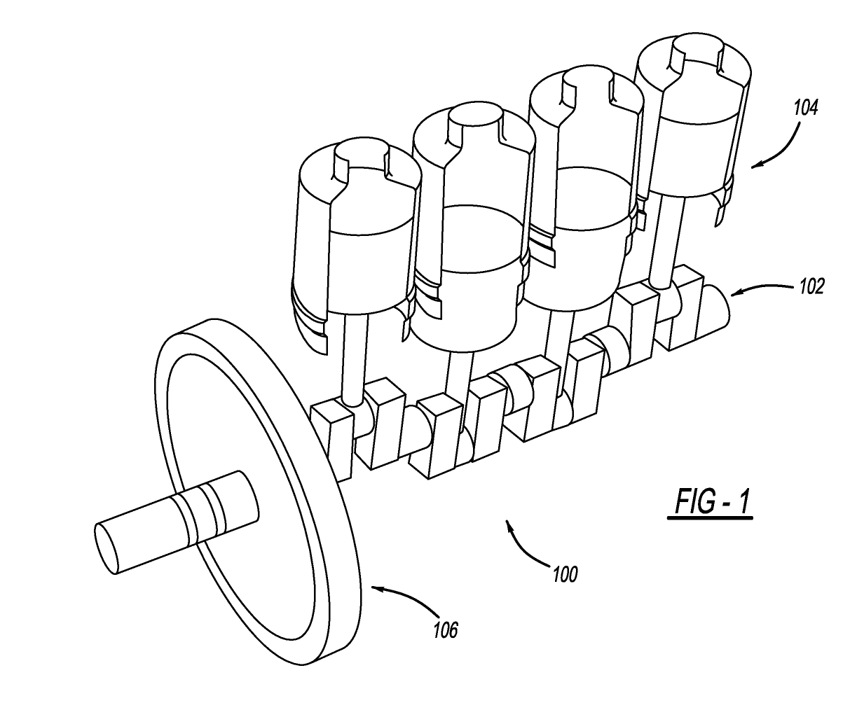

As referenced in the FIGS. 1-5, the same reference numerals are used to refer to the same components. In the following description, various operating parameters and components are described for different constructed embodiments. These specific parameters and components are included as examples and are not meant to be limiting.

The present invention, in one or more embodiments, is advantageous in being reflective of a discovery on the significance of reducing oil leakage and hence operating cost and solutions on how this reduction may be carried out. For instance, and in accordance with certain embodiments, a crankshaft or an engine assembly employing the same may be constructed with a relatively smaller number of oil grooves or groove shells, which may further be realized with a relatively smaller number of independent oil intake from a main oil supply to the crankshaft, as is detailed herein elsewhere.

In one or more embodiments, and as illustratively depicted in FIG. 1, an engine assembly generally shown at 100 includes a crankshaft 102 connected to a cylinder 104 and a flywheel 106. In this depiction, the engine assembly 100 is only shown to have four cylinders. However, the present invention does not need to be limited on the number of the cylinders and can be applied to any suitable engines with single cylinder, I2, I3, I4, I5, V6, V8, V10, V12, and V16, for instance.

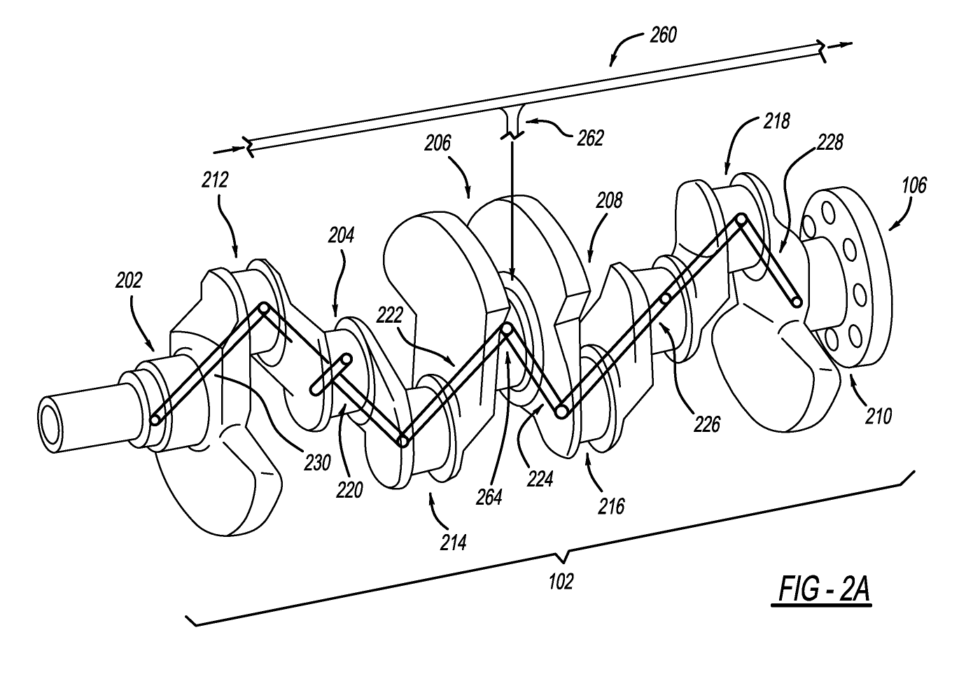

FIG. 2A illustratively depicts a perspective view of a crankshaft of the engine assembly referenced in FIG. 1. FIG. 2B illustratively depicts a cross-sectional view of the crankshaft referenced in FIG. 2A. The crankshaft 102 includes a number of main journals and a number of pin journals arranged next to one another. However, and as mentioned herein elsewhere, the number of the main journals and the number of the pin journals do not have to be limited in any certain numbers in order to carry out the present invention in one or more embodiments. For the mere purpose of illustration, five main journals and four pin journals are depicted in FIG. 2A.

Referring back to FIG. 2A, the crankshaft 102 includes first main journal 202, second main journal 204, third main journal 206, fourth main journal 208, and fifth main journal 210. The crankshaft 102 also includes first pin journal 212, second pin journal 214, third pin journal 216, and fourth pin journal 218. The main journals and pin journals are depicted in FIG. 2A to be consecutively arranged in the order of first main journal 202, first pin journal 212, second main journal 204, second pin journal 214, third main journal 206, third pin journal 216, fourth main journal 208, fourth pin journal 218 and fifth main journal 210. As is detailed herein elsewhere, the present invention in one or more embodiments is advantageous in providing a crankshaft wherein less than the total of the main journals, and in this depiction four main journals or less, may each need to be provided with a direct oil supply. The direct oil supply is provided from a source other than the crankshaft 102 itself, and often provided by an engine block (not shown) separately positioned. The crankshaft 102 according to one or more embodiments of the present invention has a reduced number of the oil grooves, which results in reduced oil leakage from main journals and reduced oil usage.

For the brevity of illustration purposes, as referring back to FIG. 2A, one and only main journal that is provided with a direct oil supply is the third main journal 206, now named as head main journal because it differs from the rest of the main journals in being provided with a direct oil supply. In this depiction, the head main journal 206 is in oil communication with a first extended passageway generally shown at 242 and a second extended passageway generally shown at 244. The first and second extended passageway 242, 244 may be formed via hole-drilling internal to one or more main journals and one or more pin journals. The first and second extended passageway 242, 244 may be of any suitable size in dimension, wherein the size in dimension may be varied according to any particular design at hand. In certain instances, the first and second extended passageway 242, 244 are each independently of no less than 1 millimeter (mm) and no greater than 15 mm in average diameter. In certain particular instances, the first and second extended passageway 242, 244 are each independently of 1.5 to 12 mm, 2 to 10 mm or 3 to 7 mm. The head main journal 206 is positioned between first-side main journals such as first main journal 202 and second main journal 204, and second-side main journals such as fourth main journal 208 and fifth main journal 210. Also, the head main journal 206 is connecting to and positioned between first-side pin journals such as first pin journal 212 and second pin journal 214, and second-side pin journals such as third pin journal 216 and fourth pin journal 218. In non-limiting sense, the phrase of “first-side” means at one side of the head main journal 206 and the phrase of “second-side” means at another opposed side of the head main journal 206.

A plurality of passageways 220, 222, 224, 226, 228, 230 may be internally formed between and communicate with the main journals and pin journals of the crankshaft 102. In one or more embodiments, the passageway 220, 222, 224, 226, 228, 230 are consecutively named as first passageway 220, second passageway 222, third passageway 224, fourth passageway 226, fifth passageway 228 and sixth passageway 230 for simplification purpose. The first passageway 220 is defined by and connects second main journal 204 and first pin journal 212 and second pin journal 214. The second passageway 222 is defined by and connects the third main journal 206 and the second pin journals 214. The third passageway 224 is defined by and connects the third main 206 and the third pin journals 216. The fourth passageway 226 is defined by and connects the fourth main journal 208 and the third and fourth pin journals 216, 218. The fifth passageway 228 is defined by and connects the fifth main journal 210 and the fourth pin journal 218. The sixth passageway 230 is defined by and connects the first main journal 202 and the first pin journal 212. Wherein the length of first and fourth passageway 220, 226 are longer than the length of the second, third, fifth and sixth passageway 222, 224, 228, 230. However, in one or more other embodiments, the number of the passageways can be varied with the number of the cylinders.

In certain embodiments, and as illustratively depicted in FIG. 2B, the first extended passageway 242 includes the second, third and sixth passageways 220, 222 and 230, and the second extended passageway 244 includes the third, fourth, and fifth passageways 224, 226 and 228. The head main journal 206 includes a common oil hole 2060 for oil communication with the second and third passageway 222, 224, therefore the first extended passageway 242 and the second extended passageway 244.

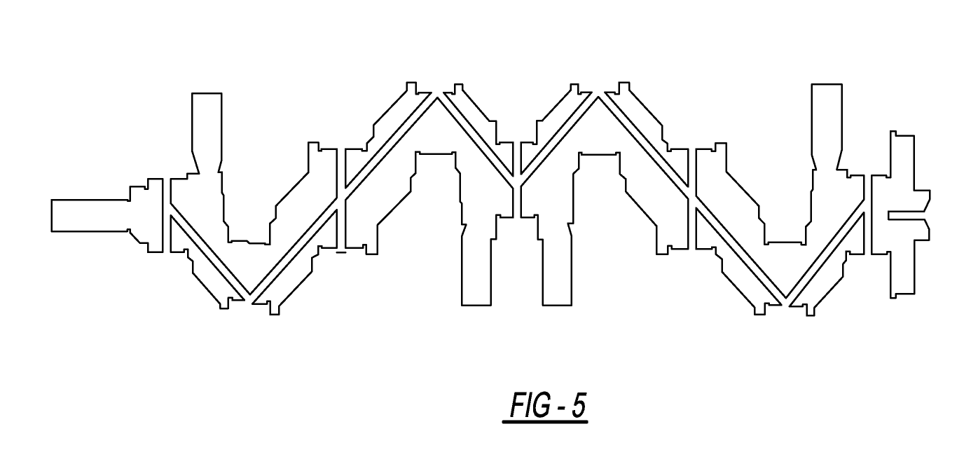

At least one of the first-side and second-side main journals may include a cross drill for oil communication with the one or more of the first and second extended passageways. The one or more cross drills may introduce oil from the first and/or second extended passageway 242, 244 to lubricate outer surface of the one or more main journals. In this example, the second and fourth main journals 204, 208 respectively has a cross drill 2041, 2081 for communication with the first and second extended passageway, shown in FIG. 2B. While, in an alternative example, all of the main journals may be provided with cross drill, respectively, shown in FIG. 5. However, the cross drill can be omitted in some cases.

The head main journal 206 supports a grooved shell (not shown) with one or more oil grooves (not shown) for supplying oil to one or more oil holes within the head main journal 206. One or more of the remainder main journals of the crankshaft 102 may also each be provided with one or more oil grooves when the one or more of the main journals other than the head main journal 206 are also receiving oil supply independently from a main oil gallery such as the main oil gallery 260. However, and as detailed herein elsewhere, the total number of the main journals that actually receive independent oil supply from the main oil gallery 260 is at least one or more fewer than the total number of the main journals physically present in the crankshaft 102. The benefit is that oil leakage and unnecessary oil waste may be effectively reduced by the reduced employment of additional structural elements needed otherwise. For the purpose of illustration, FIG. 2A depicts that the head main journal 206 is the only main journal receiving oil from the main oil gallery 260 via an oil supply conduit 262.

In a non-limiting example of the lubricating operation, and as illustratively depicted in FIG. 2A and FIG. 2B, the oil is fed from main oil gallery 260 to one or more oil holes 264 of the head main journal 206, then to first-side main journals 202, 204 and pin journals 212, 214 and second-side main journals 208, 210 and pin journals 216, 218 in two opposed directions. The oil travels through the first extended passageway 242 in the order of the head main journal 206, second pin journal 214, second main journal 204, first pin journal 212 and the first main journal 202. Similarly, and in a different direction, the oil also travels through the second extended passageway 244 in the order of the head main journal 206, third pin journal 216, fourth main journal 208, fourth pin journal 218, and fifth main journal 210. In certain embodiments and as illustratively depicted in FIG. 2A and FIG. 2B, passageways 230, 220 and 222 are directly connected to one and another in forming the first extended passageway 242 via head-to-toe type of connection. Similarly passageways 224, 226 and 228 of the second extended passageway 244 are directly connected to one or another in forming the second extended passageway 244 via head-to-toe type of connection. At least due to this head-to-toe direct connection, groove shells or oil grooves may not be needed on pin journals or any of the remaining main journals other than the head main journal 206. As a result of that, a total number of grooved shells and oil grooves may be reduced to deliver additional benefits in oil consumption reduction and hence cost effectiveness.

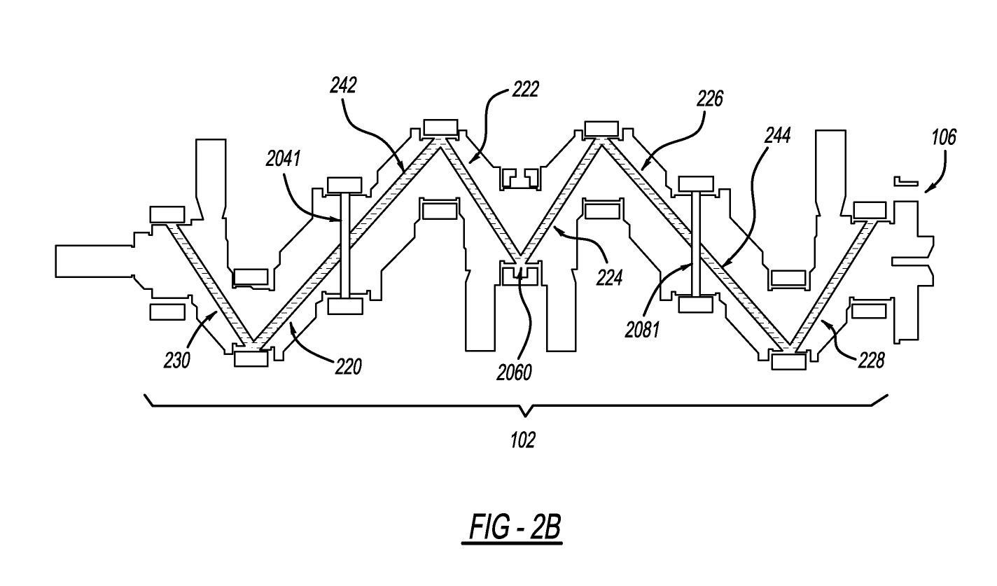

FIG. 3A illustratively depicts an alternative configuration of the head main journal 206. In this configuration, the head main journal 206 may include two spaced apart oil holes (A, B) for oil communication with the second passageway 222 of the first extended passageway 242 and the third passageway 224 of the second extended passageway 244. The distance between the two spaced apart oil holes (A, B) may be of any suitable values and may be varied according to particular design or manufacturing needs at hand. In certain instances, the oil holes A, B may be spaced apart from each other with a distance there-between of no less than 10 mm, 25 mm, or 50 mm. The distance may be determined or measured in angle when necessary. When there are separate oil holes such as oil holes A and B, each oil hole may only feed one half or close to one half of the bearings so that there is more oil supply to the bearings. In this connection, oil holes A and B can be but don't have to be connected with the cross drill as shown in FIG. 3A.

FIG. 3B illustratively depicts a further alternative configuration of the head main journal 206. In this configuration, a cross drill 302 is employed for oil communication between the second and third passageway 222, 224. In operation the cross drill 302 receives oil from an oil supply and the oil as received is transported to the passageways 222, 224 in two different directions. This may be performed with pressure externally applied to the oil source. Although the two passageways 222, 224 appear to be depicted to be connected with the cross drill 302 at the same location, it does not have to be. The two connection sites by which the passageways 222, 224 each connect to the cross drill 302 may be positioned along a longitudinal axis “L1” with any suitable values of distance.

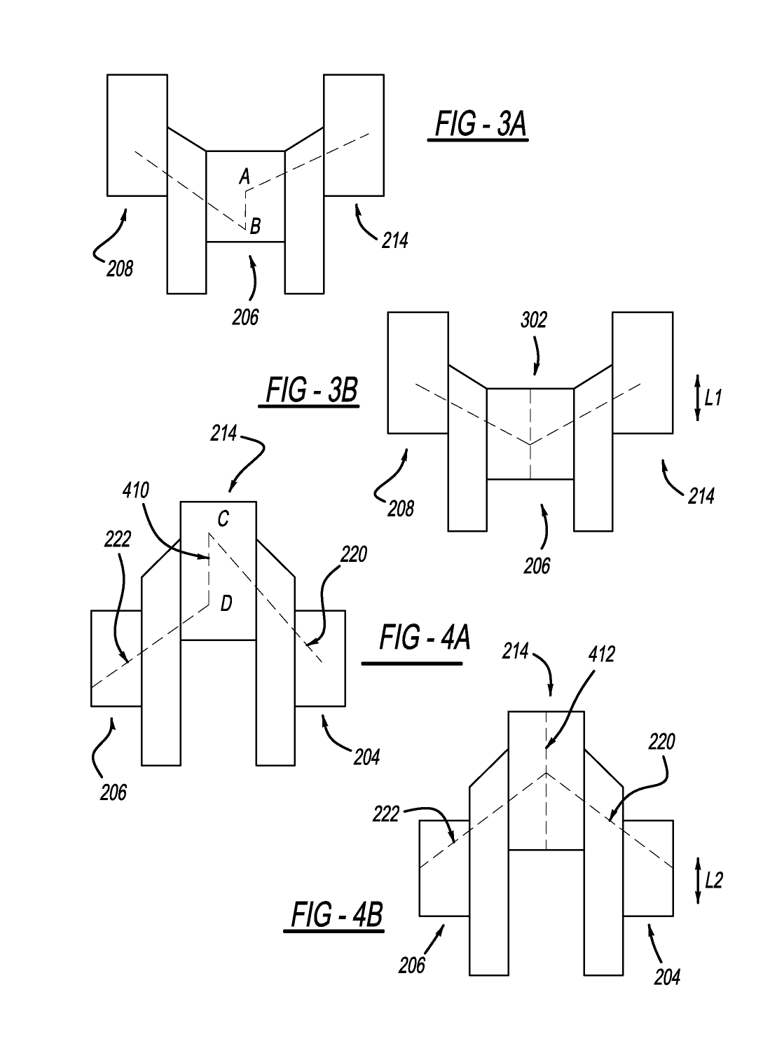

Although the first and second extended passageways 242, 244 are depicted in FIG. 2A and FIG. 2B as with head-to-toe connections between any two adjacent passageways, the connections may be independently varied. For instance, and as further detailed herein elsewhere in relation to FIGS. 3A, 3B, 4A, and 4B, one or more of the main journals and one or more of the pin journals may be provided with spaced apart oil holes or a cross drill. For instance also, and as illustratively depicted in FIG. 3A and FIG. 4A, spaced apart oil holes A, B and C, D may be connected by a lead channel, respectively. Referring back to FIG. 4A, the pin journal 214 includes two spaced apart oil holes (C, D) for oil communication with the first and second passageways 220, 222. The spaced apart oil holes (C, D) are connected by a lead channel 410 positioned within the pin journal 214 itself.

As illustratively depicted in FIG. 4B, the design of a cross drill referenced in FIG. 3B may be suitably applied to a pin journal such as the pin journal 214. The difference is that no more independent oil supply is needed. In other words, in comparison to the cross drill 302 for the head main journal 206 which receives an independent source of lubricating oil, the pin journal 214 does not necessarily need to have an independent source of oil supply. In operation, the passageways 222, 220 are in oil communication via the cross drill 412. As illustratively depicted in FIG. 4B, passageways 220 and 222 intersect each other inside the pin journal 214, and the cross drill 412 takes the oil to the journal surface of the pin journal 214. Referring back to FIG. 4A, oil holes C and D may be located on the journal surface, and then a cross drill such as the cross drill 412 helps connect the oil holed C and D such that oil flow may continue. If, however, the oil holes C and D are at same spot on the pin journal surface, a cross drill for connecting C and D such as the cross drill 412 of FIG. 4B may not be needed. Although the two passageways 222, 220 appear to be depicted to be connected with the cross drill 412 at the same location, it does not have to be. The two connection sites by which the passageways 222, 220 each connect to the cross drill 412 may be positioned along a longitudinal axis “L2” with any suitable values of distance.

In one or more embodiments, the term “extended” refers to an oil passageway formed by unbroken wall with no intentionally constructed interruptions in the material forming the wall. However, and under certain instances, the term “extended” may also refer to oil passageways formed with oil continuity and hence permits certain interruptions in physical material forming the oil passageways. By way of example, and as detailed herein above, cross drills 302 and 412 each present a material interruption between the passageways 222, 224, and 222, 220, respectively. However the possible existence of oil communication or oil continuity among the passageways and their connecting cross drill makes the entire connection continuous.

In one or more embodiments, the disclosed invention as set forth herein overcomes the challenges faced by known production of crankshaft. However, one skilled in the art will readily recognize from such discussion, and from the accompanying drawings and claims that various changes, modifications and variations can be made therein without departing from the true spirit and fair scope of the invention as defined by the following claims.

1. A crankshaft for an engine, comprising:
a first number of main journals including a head main journal positioned between one or more first-side main journals and one or more second-side main journals, the head main journal supporting a grooved shell with one or more oil grooves;
a second number of pin journals including one or more first-side pin journals and one or more second-side pin journals, the head main journal connected to and being positioned between the first-side and second-side pin journals;
a first extended passageway to transport oil from the head main journal to the one or more first-side main journals and the one or more first-side pin journals; and
a second extended passageway to transport oil from the head main journal to the one or more second-side main journals and the one or more second-side pin journals.

2. The crankshaft of claim 1, further comprising another or more grooved shell with a total number thereof being less than the first number of main journals.

3. The crankshaft of claim 2, wherein the first extended passageway includes a first short passageway defined by one of the first-side main journals and one of the first-side pin journals and a first long passageway defined by one of the first-side main journals and two of the first-side pin journals, the first short passageway being arranged next to the first long passageway, and wherein the second extended passageway includes a second short passageway defined by one of the second-side main journals and one of the second-side pin journals and a second long passageway defined by one of the second-side main journals and two of the second-side pin journals, the second short passageway being arranged next to the second long passageway.

4. (canceled)

5. The crankshaft of claim 1, wherein at least one of the first-side and second-side main journals includes a cross drill for oil communication with the one or more of the first and second extended passageways.

6. (canceled)

7. The crankshaft of claim 1, wherein at least one of the first-side and second-side pin journals includes two spaced apart oil holes for oil communication with one or both of the first and second extended passageways.

8. The crankshaft of claim 7, wherein the spaced apart oil holes are connected by a lead channel positioned within the at least one of the first-side and second-side pin journals.

9. The crankshaft of claim 7, wherein the spaced apart oil holes are connected by a cross drill.

10. An engine assembly including a crankshaft, the crankshaft comprising:
journals consecutively arranged as first main, first pin, second main, second pin, third main, third pin, fourth main, fourth pin, and fifth main, wherein a first passageway is defined by and connects the second main journal and first and second pin journals to transport oil from the second pin journal to the second main journal and then to the first pin journal.

11. The engine assembly of claim 10, wherein a second passageway is defined by and connects the third main and the second pin journals such that the second passageway is to transport oil from the third main journal to the second pin journal.

12. The engine assembly of claim 11, wherein a third passageway is defined by and connects the third main and the third pin journals such that the third passageway is to transport oil from the third main journal to the third pin journal.

13. The engine assembly of claim 12, wherein a fourth passageway is defined by and connects the fourth main journal and the third and fourth pin journals such that the fourth passageway is to transport oil from the third pin journal to the fourth main journal and then to the fourth pin journal.

14. The engine assembly of claim 13, wherein a fifth passageway is defined by and connects the fifth main and the fourth pin journals such that the fifth passageway is to transport oil from the fourth pin journal to the fifth main journal.

15. The engine assembly of claim 14, wherein a sixth passageway is defined by and connects the first main and the first pin journals such that the sixth passageway is to transport oil from the first pin journal to the first main journal.

16. The engine assembly of claim 15, wherein the third main journal includes two spaced apart oil holes for oil communication with the second and third passageways, respectively.

17. The engine assembly of claim 11, wherein the second pin journal includes two spaced apart oil holes for oil communication with the first and second passageways, respectively, and wherein the two spaced apart oil holes are connected with a lead channel defined within the second pin journal.

18. The engine assembly of claim 10, further comprising a grooved shell supported on the third main journal, the grooved shell including an oil groove for facilitating oil passage to the third main journal.

19. The engine assembly of claim 18, further comprising an oil supply conduit connecting the grooved shell on the third main journal and an engine block.

20. An engine assembly including a crankshaft, the crankshaft comprising:
journals consecutively arranged as first main, first pin, second main, second pin, third main, third pin, fourth main, fourth pin, and fifth main, of which only the third main journal includes a grooved shell to receive oil from an oil gallery,
wherein a first passageway is defined by and connects the second main journal and first and second pin journals, a second passageway is defined by and connects the third main and the second pin journals, a third passageway is defined by and connects the third main and the third pin journals, a fourth passageway is defined by and connects the fourth main journal and the third and fourth pin journals, a fifth passageway is defined by and connects the fifth main and the fourth pin journals, and a sixth passageway is defined by and connects the first main and the first pin journals, such that oil is to move in a first direction from the third main journal to the second pin journal, the second main journal, the first pin journal, and then to the first main journal via the second, first and sixth passageways, and such that oil is to move in a second direction opposite of the first direction from the third main journal to the fourth pin journal, the fourth main journal, the fifth pin journal and then to the fifth main journal via the third, fourth and fifth passageways.

21. The engine assembly of claim 10, wherein less than five of the first through fifth main journals each include a grooved shell to receive oil from a main oil gallery.

22. The crankshaft of claim 1, wherein at least one of the first and second extended passageways includes a wall defining a cavity to transport oil there-through.
